(19) United States
(12) Patent Application Publication
(10) Pub. No.: US 2022/0417768 A1
(43) Pub. Date: Dec. 29, 2022

(54) DYNAMIC SUBSCRIBER POLICY CONFIGURATION IN A COMMUNICATION NETWORK BASED ON REAL-TIME BIDDING

(71) Applicant: DISH Wireless L.L.C., Englewood, CO (US)

(72) Inventors: Kevin Yao, Cheyenne, WY (US); Prashant Raghuvanshi, Parker, CO (US)

(21) Appl. No.: 17/361,673

(22) Filed: Jun. 29, 2021

(51) Int. Cl. H04W 24/02; H04W 28/02; H04W 72/12; H04W 8/18; G06N 20/00

(52) U.S. Cl. CPC H04W 24/02; H04W 28/0268; H04W 72/1205; H04W 8/18; G06N 20/00

(57) ABSTRACT

Techniques are described for dynamic bid-driven reconfiguration in a wireless communication network. An analytics front-end system (AFES) can be implemented in a provider network. The AFES can obtain network service experience (NSE) predictions derived by a network data analytics function (NWDAF) based on network status data received from back-end network functions of the provider network. The AFES can generate bid options based on the NSE predictions, each having a respective NSE definition and bid value. The bid options can be output to a user bidding interface, via which a user can review and select the bid options. In response to the user selecting one of the bid options, the AFES can direct a network policy server to update one or more subscriber policy definitions for one or more subscribers based on the respective NSE definition of the selected bid option, thereby dynamically updating at least one subscriber's NSE.

### FIELD

Embodiments relate generally to provision of network communication services over communication networks; and, more particularly, to dynamic generation of real-time bidding options based on network analytics and use of such real-time bidding options to dynamically update subscriber network communication policies.

### BACKGROUND

Communication services are typically offered to consumers via subscription plans that contractually define particular service parameters, such as relating to price and quality of service (QoS). Such subscription plans tend conventionally to be offered under a static tiered approach, by which a service provider offers a number of tiers, each having respective service parameters at a particular price. A consumer can subscribe to one of the offered service tiers, and back-end network functions of the provider's network, such as a network policy server, is configured to handle the now-subscriber's communications in accordance with the subscribed-to service tier. Making subsequent changes to parameters of the subscriber's policy tends conventionally to involve developing a new/modified service tier, updating network setting configurations in network functions of the provider's network to recognize subscribers and handle traffic under the new/modified service tier, and establishing a new/modified contractual relationship with the subscriber, etc. Subscribers and providers tend to make such changes only when additional value of such a change is sufficient to offset the appreciable amounts of time and other resources consumed in making such a change.

### SUMMARY

Embodiments of the present invention relate to dynamic bid-driven reconfiguration of subscriber network experience in a wireless communication network. An analytics front-end system (AFES) can be implemented in a provider network. The AFES can obtain network service experience (NSE) predictions and other network capabilities use cases derived by a network data analytics function (NWDAF) based on network status data received from back-end network functions of the provider network. The AFES can generate bid options based on the NSE predictions, each having a respective NSE definition and bid value. The bid options can be output to a user bidding interface, via which a user can review and select the bid options. In response to the user selecting one of the bid options, the AFES can direct a network policy server to update one or more subscriber policy definitions for one or more subscribers based on the respective NSE definition of the selected bid option, thereby dynamically updating at least one subscriber's NSE. In some implementations, responsive to the bid selection, the AFES can also direct contracting, value exchange, and/or other functions involved in effecting changes to subscriber NSE at the network policy server.

According to one set of embodiments, a system is provided for dynamic bid-driven reconfiguration in a wireless communication network. The system includes: a network function interface to communicatively couple with a network data analytics function (NWDAF) and a network policy server via a communication network; an application programming interface to communicatively couple with a plurality of subscriber devices via the communication network, the subscriber devices being associated with subscribers to wireless communication services via the communication network managed by the network policy server based on respective subscriber policy definitions; an analytics front end processor coupled between the network function interface and the application programming interface; and a non-transient memory having instructions stored thereon. When the instructions are executed, they cause the analytics front end processor to perform steps including: obtaining, via the network function interface, one or more network service experience (NSE) predictions derived by the NWDAF based on network status data received from a plurality of back-end network functions; generating a set of bid options based on the NSE predictions, each of the set of bid options corresponding to a respective NSE definition and a respective bid value; outputting, via the application programming interface, the set of bid options for display by a user bidding interface; receiving, via the application programming interface, responsive to the outputting, a bid response indicating a selected one of the set of bid options that was selected via the user bidding interface; and directing the network policy server, via the network function interface, to update one or more of the respective subscriber policy definitions for one or more of the subscribers according to the respective NSE definition corresponding to the selected one of the set of bid options.

According to another set of embodiments, a method is provided for dynamic bid-driven reconfiguration in a wireless communication network. The method includes: obtaining, by an analytics front-end system (AFES), one or more network service experience (NSE) predictions and other network capabilities use cases derived by a network data analytics function (NWDAF) based on network status data received from a plurality of back-end network functions; generating, by the AFES, a set of bid options based on the one or more NSE predictions, each of the set of bid options corresponding to a respective NSE definition and a respective bid value; outputting, via an application programming interface of the AFES, the set of bid options for display by a user bidding interface, the application programming interface to communicatively couple with a plurality of subscriber devices associated with subscribers to wireless communication services managed by a network policy server based on respective subscriber policy definitions; receiving, via the application programming interface of the AFES, responsive to the outputting, a bid response indicating a selected one of the set of bid options that was selected via the user bidding interface; and directing the network policy server, by the AFES, to update one or more of the respective subscriber policy definitions for one or more of the subscribers according to the respective NSE definition corresponding to the selected one of the set of bid options.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 shows an illustrative network environment as a context for embodiments described herein;

FIG. 2 shows a partial network environment, including an illustrative analytics front-end system (AFES) in communication with subscriber devices, according to embodiments described herein;

FIG. 3 shows an illustrative analytics front end processor implementing an artificial intelligence (AI) bid generator, according to various embodiments;

FIG. 4 provides a schematic illustration of one embodiment of a computer system that can implement various system components and/or perform various steps of methods provided by various embodiments; and

FIG. 5 shows a flow diagram of an illustrative method for dynamic bid-driven reconfiguration in a wireless communication network, according to various embodiments.

In the appended figures, similar components and/or features may have the same reference label. Further, various components of the same type may be distinguished by following the reference label by a second label (e.g., a lower-case letter) that distinguishes among the similar components. If only the first reference label is used in the specification, the description is applicable to any one of the similar components having the same first reference label irrespective of the second reference label.

### DETAILED DESCRIPTION

Embodiments of the disclosed technology will become clearer when reviewed in connection with the description of the figures herein below. In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

Communication services are conventionally offered to consumers via static tiered subscription plans that contractually define particular service parameters, such as relating to price and quality of service (QoS), according to one or more defined service tiers. A consumer can subscribe to (e.g., enter a contract for, or purchase a non-contract static service tier via prepaid subscription for) one of the offered service tiers, and back-end network functions of the provider's network, such as a network policy server, are configured to handle the now-subscriber's communications in accordance with the subscribed-to service tier. For example, a particular subscriber may purchase a wireless communication service plan tier that generally promises unlimited data communications for a particular price per month. That tier may also be associates with other QoS-related parameters, such as a target data speed (e.g., bitrate, throughput, bandwidth, etc.), throttling of the data speed after a particular amount of data has been used in the subscription period, communication over a particular network and/or radio technology (e.g., fourth generation (“4G”), fifth generation (“5G”), etc.), and the like.

Over the course of a subscriber's service relationship with the provider, scenarios may arise in which a temporary or permanent change in tier (or individual service parameters) would provide the subscriber and/or the provider with additional value. For example, changes in a subscriber's demand for network resources and/or changes in a provider's supply of network resources can change the value of those network resources to the subscriber and/or the provider. However, making changes to the subscriber's service relationship (i.e., to the subscriber policy that controls how the subscriber's communications are handled by the network and/or the corresponding price of such handling) under the conventional static tiered approach tends to involve developing a new/modified service tier, updating network setting configurations in network functions of the provider's network to recognize subscribers and handle traffic under the new/modified service tier, and establishing a new/modified contractual relationship with the subscriber, etc. As such subscriber policy changes tend conventionally to consume appreciable amounts of time and other resources, subscribers and providers tend to make such changes infrequently, and/or only when additional value achieved by such a change would more than offset the resource consumption involved in making the change.

Embodiments provide techniques for facilitating more dynamic control of subscriber policy definitions that are not reliant on pre-defined static tiers. Network analytics can be used to generate real-time network service experience (NSE) predictions, to associate the different NSE predictions with corresponding value to subscribers and/or providers, and to generate and offer corresponding bid options to users (e.g., to subscriber users and/or to provider users). Subscriber policy definitions can be dynamically controlled in the network responsive to user selection of the bid options. For example, a subscriber can use a user bidding interface of an application on a mobile device to view and select bid options, thereby making a substantially real-time change to their subscriber experience based on present network analytics data.

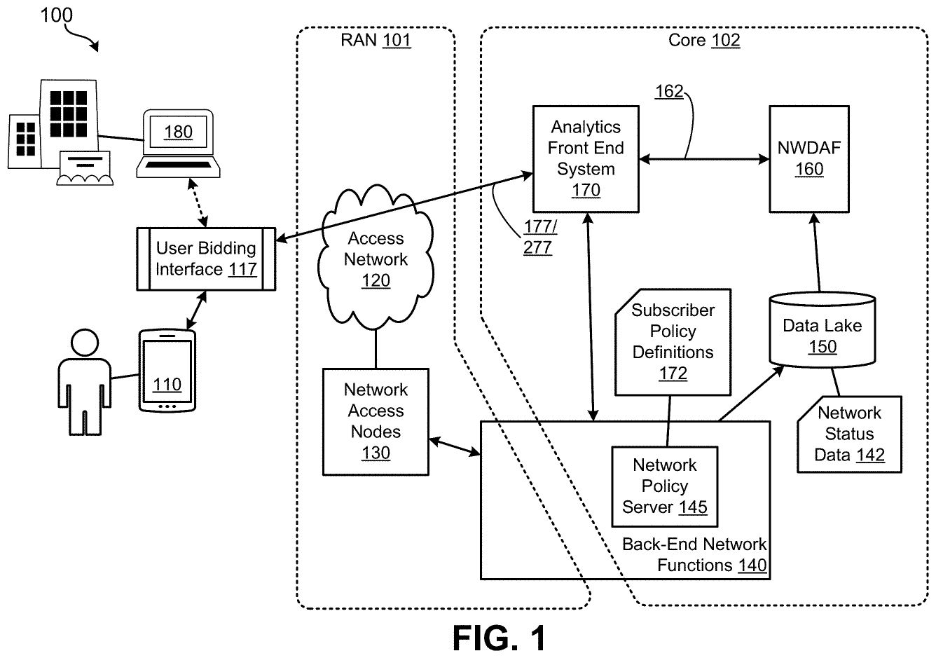

FIG. 1 shows an illustrative network environment 100 as a context for embodiments described herein. The network environment 100 include a number of provider-side network functions in communication with subscriber devices 110 via one or more access networks 120. The provider-side network functions include network access nodes 130, back-end network functions 140, a data lake 150, a network data analytics function (NWDAF) 160, and an analytics front-end system (AFES) 170. The provider-side network functions can generally implement a radio access network (RAN) 101 and a network core 102. For example, the network access nodes 130, the access networks 120 provided by the network access nodes 130, and some back-end network functions 140 can make up the RAN 101 portion of the network environment 100; and other back-end network functions 140, the data lake 150, the NWDAF 160, and the AFES 170 can make up the core 102 portion of the network environment 100.

In general, the subscriber devices 110 are provided with communication services via the network access nodes 130 and the access networks 120, and the provided communication services are handled by the back-end network functions 140 in accordance with subscriber policy definitions 172. In the course of handling subscriber communications, the back-end network functions 140 can obtain and maintain different types of network status data 142. The network status data 142 can be collected in the data lake 150 for use by the NWDAF 160. The NWDAF 160 includes machine learning engines that can use the network status data 142 to generate network service experience (NSE) predictions 162. The AFES 170 can use the NSE predictions to generate a set of bid options 177, each having a corresponding NSE definition and bid value. The set of bid options 177 can be offered to one or more users via user bidding interfaces 117 implemented on the subscriber devices 110. Responsive to user selections of the bid options 177 via the user bidding interfaces 117, the AFES 170 can direct the back-end network functions 140 to update the subscriber policy definitions 172, thereby updating the manner in which the subscribers' communications over the access networks 120 are handled.

Embodiments of the subscriber devices 110 can include any suitable communication device for facilitating subscriber network communication services with the network access nodes 130 via the access networks 120. Some implementations of the subscriber devices 110 include mobile devices, such as smartphones, laptop computers, tablet computers, electronic readers, smart wearable devices (e.g., smart watches, network-connected fitness trackers, etc.), mobile internet-of-things (IoT) devices, etc. Other implementations of the subscriber devices 110 include appliances, or other devices not intended to be mobile devices, such as desktop computers, television receivers, modems, routers, IoT appliances (e.g., smart televisions, smart thermostats, smart refrigerators, etc.), network-connected security systems, etc. In general, the subscriber devices 110 are used to communicate subscriber communications data (SCD) over the access networks 120. The SCD can include telephony data, mobile messaging data, Internet browsing data, streaming media data, and/or any other suitable data; and the SCD can be communicated in any suitable formats, such as using any suitable packet formats, protocols, modulation and coding schemes, encryption, metadata, etc.

The subscriber devices 110 can communicate with the provider-side network functions over any suitable access networks 120. The access networks 120 can include any type of wired or wireless network, or combination thereof. Merely by way of example, the access networks 120 may include a satellite cable network, a wireline network, an optical fiber network, a telecommunications network, an intranet, an Internet, a local area network (LAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. The different types of access networks 120 can support different types of communications, such as different communication protocols, different data rates, different radio technologies, different modulation and coding schemes, etc. In some cases, the access networks 120 can include subscriber premises network links, last-mile network links, back-haul network links, and/or any other suitable network links.

Any of these and/or other access networks 120 are used to communicatively couple the subscriber devices 110 with the one or more network access nodes 130, such as any suitable wired or wireless network access points (e.g., base stations and/or internet exchange points). As the subscriber devices 110 may be coupled with one or more access networks 120 via one or more wired or wireless communication links, the network access nodes 130 can generally include any routers, switches, macro cells, femtocells, relays, receivers, etc. In some cases, the network access nodes 130 include one or more general packet radio service (GPRS) support nodes, such as defined support nodes, Session Management Function (SMF), User Plane Function (UPF), and/or Policy Control Function (PCF). For the sake of example, many wireless subscriber devices 110 and access networks 120 are configured for communications of SCD and other network data in accordance with one or more standards promulgated by a number of standards setting organizations under the umbrella of the Third Generation Partnership Project (3GPP). Some 5G standards use so-called “next-generation node B” (gNodeB, or gNB) network access nodes 130.

Such network access nodes 130 effectively provide a communicative coupling between the network access nodes 130 and the provider-side network functions (e.g., interfacing between a subscriber's local cellular network connection and the greater telephone network, Internet, etc.). The manner of handling SCD communications from and to the subscriber devices 110 can be controlled by the network access nodes 130 in accordance with network configuration settings. For example, the network configuration settings can affect which access networks 120 and radio technologies are used to communicate SCD, which bitrates are used or supported for communications, whether and when to throttle data speeds, which network slices to use (e.g., in a 5G network), whether to use adaptive bitrate encoding and/or other traffic shaping schemes, whether to use dedicated infrastructure, etc. In some cases, the network configuration settings are defined in terms of subscriber experience parameters, such as a target (e.g., contractually guaranteed, advertised, nominal, etc.) throughput, data speed, bandwidth, reliability (e.g., minimum downtime), etc.

The network configuration settings can be defined in accordance with subscriber policy definitions 172. For example, each subscriber is associated with a subscriber policy definition 172. Each subscriber policy definition 172 can include one or more sub-definitions, such as one for each subscriber household, one for each subscriber device 110, one for each member of a subscriber's household, etc. When the subscriber enters a subscription agreement, or buys a pre-packaged service plan with predefined quality of service (QoS) with a communication services provider, the subscriber policy definition 172 is created and stored in a network policy server 145 (also called a policy control function, or PCF), which is one of the back-end network functions 140. Other back-end network functions 140 can also be involved with the subscriber relationship, such as with back-end handling of the SCD, with subscriber billing, with managing subscriber user data, etc. For example, other back-end network functions 140 can include an authentication server function (AUSF), user data management (UDM) function, access and mobility management function (AMF), session management function (SMF), user plane function (UPF), mobility management entity (MME), online and/or offline charging functions, billing and/or mediation functions, Internet protocol multimedia subsystem (IMS) function, and/or any other suitable network functions. Each back-end network function 140 can be implemented in any suitable manner, such as in dedicated hardware appliances, shared hardware appliances, software functions running in a hardware environment, etc.

During operation of the communication network, the back-end network functions 140 can obtain many types of network status data 142. The network status data 142 can include any types of data relating to use of communications resources on the communication network, including data relating to the supply of and demand for such communication resources. Some network status data 142 relates to present network-level data, such data being obtained and/or generated by back-end network functions 140 that indicates present allocations of bandwidth on different network slices, amounts of allocated bandwidth that are presently being consumed, etc. Other network status data 142 relates to present subscriber-level data, such as data being obtained and/or generated by back-end network functions 140 that indicates present usage of allocated bandwidth by a particular user or group of users, types of SCD presently traversing the network (e.g., which applications, which data protocols, etc.), subscriber usage in relation to subscription allocations (e.g., whether a subscriber is far below a present data allowance, approaching or exceeding a data cap, etc.), etc. Other network status data 142 relates to historic data, such as data being obtained and/or generated by back-end network functions 140 that indicates and/or informs statistics, trends, moving averages, anomalies, spikes, and/or the like. Some examples of network status data 142 that can be obtained by 5G core and/or 5G IMS functions can include data relating to faults, alarms, performance metrics, logs, configurations (e.g., config changes, notifications, etc.), traces (e.g., including open trace), etc. In some implementations, other back-end network functions 140 or groups of functions, such as 5G transport functions, 5G radio access network (RAN) functions, networking and data center fabric pipeline functions, and/or the like, can include similar network status data 142 relating to faults, alarms, performance metrics, logs, configurations, traces, topology, etc.

Some or all of the network status data 142 can be collected in a data lake 150. The term “data lake” is used herein to generally refer to any suitable manner of collecting the network status data 142 to be accessible and usable by the NWDAF 160, as described herein. The term “data lake” is not intended to limit embodiments to any particular storage format or technology. In some embodiments, the data lake 150 is a generally un-structured big data repository that stored the network status data 142 in one or more raw data formats (e.g., as structured and/or unstructured raw data). For example, a flat architecture is used to store the network status data 142 in the manner that it is obtained and/or generated by, and received from the back-end network functions 140. In some such implementations, each element of network status data 142 is associated with identifying data, such as a unique identifier, a metadata tag, etc.; and the identifying data can be used to identify relevant sets of the data in response to a query by another system (e.g., by the NWDAF 160). In other embodiments, the data lake 150 can be implemented as a data warehouse, or the like, in which the data is stored in accordance with particular organizational schema. For example, the data lake 150 can be implemented in whole, or in part, as a relational database, a hierarchical database, a file system, etc.

Embodiments of the NWDAF 160 query the data lake 150 to generate various types of network analytics, which can be presented in the form of network service experience (NSE) predictions 162. Examples of the various types of network analytics that can be provided by the NWDAF 160 include network domain analytics, customer insight analytics, business insight analytics, NWDAF 160 support analytics, self-organizing network (SON) support analytics, churn analysis analytics, open RAN (ORAN) support analytics, descriptive analytics, radiofrequency planning tool analytics, predictive analytics, prescriptive analytics, etc. In some embodiments, some or all of the network analytics are generated by advanced artificial intelligence and/or machine learning (AI/ML) functions of the NWDAF 160. Such AI/ML functions can be built around algorithms trained on network status data 142 to perform predictive analytics, anomaly detection, trend analysis, clustering, and/or the like. Some embodiments of the NWDAF 160 are implemented in accordance with 5G standards promulgated by 3GPP, such as technical standard (TS) 29.520, TR 23.791, and others. For example, the 3GPP standards define manners in which the NWDAF 160 can query data and perform analytics on the data to generate the NSE predictions 162. Some examples of NSE predictions 162 that can be generated by the NWDAF 160 include load-level computations and predictions for one or more network slice instances, service experience computation and prediction for one or more applications, service experience computation and prediction for one or more subscriber devices 110, load analytics information and prediction for one or more back-end network functions 140 or other network functions, network load performance computations and future load prediction, expected behavior prediction for one or more subscriber devices 110, abnormal behavior and/or anomaly detection for one or more subscriber devices 110, mobility-related information and prediction for one or more subscriber devices 110, communication pattern prediction for one or more subscriber devices 110, current and/or predicted congestion information for one or more locations, quality of service (QoS) sustainability (e.g., involving reporting and predicting QoS changes), etc. In some embodiments, the NWDAF 160 is implemented as a single centralized NWDAF 160. In other embodiments, the NWDAF 160 is implemented using a distributed architecture. For example, the NWDAF 160 can include one or more edge NWDAFs 160 in communication with a central NWDAF 160 (e.g., in a hub-spoke architecture).

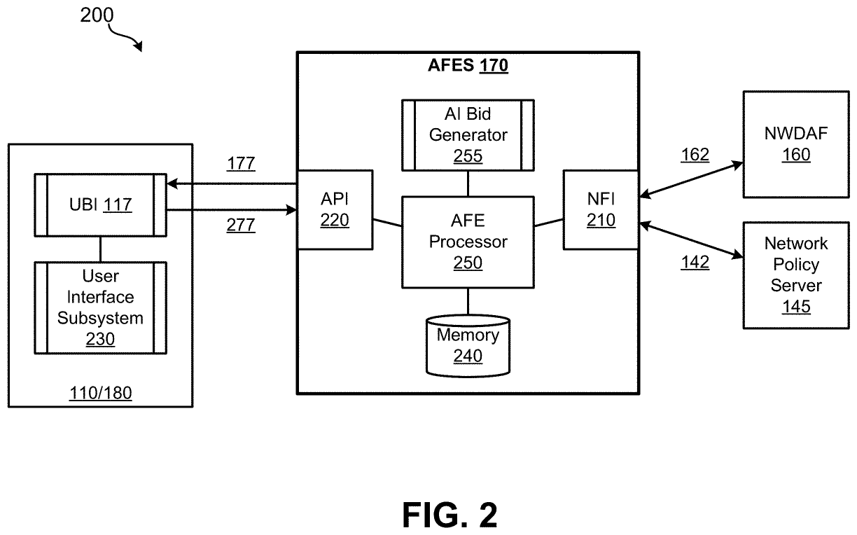

As noted above, embodiments of the analytics front-end system (AFES) 170 generate sets of bid options 177 based on the NSE predictions 162 output by the NWDAF 160. The AFES 170 can offer the set of bid options 177 to users (e.g., subscriber devices 110 and/or provider devices 180), the users can notify the AFES 170 of selection of one or more of the offered bid options 177, the AFES 170 can direct the back-end network functions 140 (e.g., the network policy server 145) to update the subscriber policy definitions 172 based on the selected bid options 177. More detail as to the interactions between the AFES 170 and one or more users is described with reference to FIG. 2.

FIG. 2 shows a partial network environment 200, including an illustrative analytics front-end system (AFES) 170 in communication with subscriber devices 110, according to embodiments described herein. The AFES 170 can be implemented in any suitable manner by any suitable components and/or locations in the network environment 200. As illustrated, the AFES 170 includes a network function interface 210, an application programming interface 220, and an analytics front end processor 250 coupled between the network function interface 210 and the application programming interface 220. In some embodiments, the AFES 170 includes a non-transient memory 240 having instructions stored thereon, which, when executed, cause the analytics front end processor 250 to perform various functions described herein. Embodiments of the analytics front end processor 250 can be implemented by a central processing unit CPU, an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction set (RISC) processor, a complex instruction set processor (CISC), a microprocessor, or the like, or any combination thereof.

Embodiments of the network function interface 210 provide communicative coupling between the analytics front end processor 250 and the NWDAF 160. For example, the analytics front end processor 250 can query the NWDAF 160 for NSE predictions 162 and receive NSE predictions 162 from the NWDAF 160 via the network function interface 210. In some embodiments, the NWDAF 160 operates according to a request or subscription model, and the AFES 170 subscribes to the NWDAF 160 as a network function to query the NWDAF 160 for NSE predictions 162 relating to itself and/or to other network functions. For example, the interactions between the AFES 170 (as a subscribed network function) and the NWDAF 160 can be implemented as a data analytics architecture in accordance with 3GPP TS 23.288 (which described the AFES 170 acting as an application function, or “AF”). As noted above, the NSE predictions 162 are generated by the NWDAF 160 based on network status data 142 received from the back-end network functions 140 and collected in the data lake 150.

Responsive to receiving the NSE predictions 162, the analytics front end processor 250 can generate a set of bid options 177. Each of the set of bid options 177 is generated to have a respective NSE definition and a respective bid value. NSE for a particular subscriber at any particular time can be a direct result of that subscriber's subscriber policy definition 172. For example, the apparent data speed, network availability, cost of service, and other factors that contribute to the subscriber's experience of using communication services over the network can be a direct result of the subscriber's allocated bandwidth, network slice configuration, guaranteed throughput, network infrastructure assignments, and/or other configured network attributes under the subscriber policy definition 172. Additionally, the NSE of the subscriber can be impacted at any particular time by current network status, such as present demands for and availability of bandwidth, congestion of network nodes, data error rates and/or packet losses, and/or other impacts to present network resource supply, and/or planned or unplanned outages and/or downtime of the network. For example, subscribers may experience long load times for Internet content, network interruptions, and/or other adverse impacts to their NSE at certain times of day when more subscribers are using shared network infrastructure, during certain weather conditions, etc.

In such a context, any particular NSE at any particular time can have some amount of value to a subscriber and/or to a provider. As one set of example scenarios, a particular subscriber generally uses network resources at a level well within the bounds of the subscriber policy definition 172, but the subscriber occasionally finds value in having additional available bandwidth. For example, the subscriber may be close to reaching or exceed a data usage cap and is temporarily willing to incur an additional cost to raise the cap, the subscriber may have an important videoconference and is temporarily willing to incur an additional cost to be guaranteed a higher quality of service, the subscriber may want to binge watch a newly released season of a beloved television program and is temporarily willing to incur an additional cost to stream the content to a mobile device at a high bitrate. As another set of example scenarios, a first subscriber tends to under-utilize allocated bandwidth and, therefore, attributes little value to receiving additional bandwidth. However, the network is presently congested, and the first subscriber's unused bandwidth is highly valuable to a second subscriber and/or to the provider. The first subscriber may temporarily be willing to receive payment (e.g., a reduction in service cost) for a reduction in QoS, while the second subscriber is temporarily willing to incur an additional cost for an increase in QoS.

Based on the above, it can be generally assumed that any particular subscriber (and/or provider) at any particular time attributes a particular value (e.g., both objectively and subjectively) to the present attributes of their subscriber policy definition 172, such that the present attributes and the present attributed value forms a present value proposition. For example, the present value proposition for the subscriber can be a function of the present actual NSE being experienced by the subscriber, in relation to the present subscriber policy definition 172, the amount presently being paid by the subscriber for the present subscriber policy definition 172. Embodiments of the analytics front end processor 250 seek to generate the bid options 177, such that each respective NSE definition and corresponding bid value are generated to represent a respective value proposition that is different from the present value proposition. The respective value propositions for different bid options 177 can account for value to the same subscriber and/or to other subscribers, to the communication service provider, to other providers, etc. In some implementations, generation of the bid options 177 can include additional considerations, such as seeking to maximize the respective value proposition(s) from the subscriber's perspective to maximize the chance that the subscriber will select one of the offered bid options 177 (as opposed to maintaining the present subscriber policy definition 172).

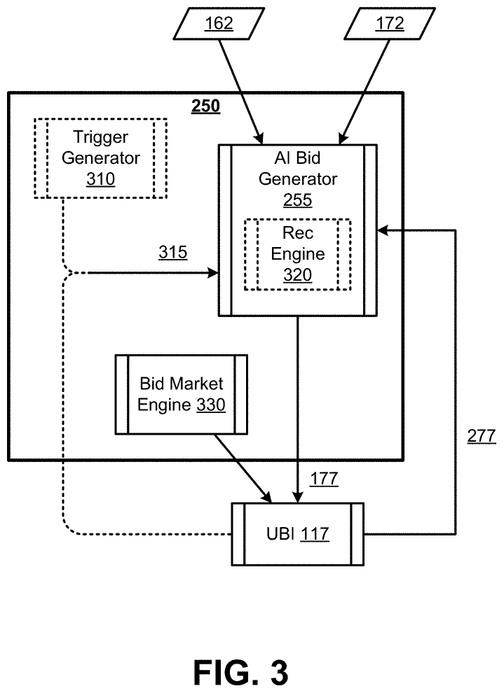

Embodiments of the analytics front end processor 250 use artificial intelligence (AI) to automatically generate the bid options 177 based on advanced machine learning (ML) algorithms. For the sake of illustration, FIG. 3 shows an illustrative analytics front end processor 250 implementing an AI bid generator 255, according to various embodiments. Operations of the AI bid generator 255 can include automated generation of multiple candidate options and their associated value propositions, automated generation of relative valuations for the candidate options (e.g., relative to a particular user or group of users, to one or more timeframes, etc.), and automated determination of the manner of presentation of those candidate options as bid options 177 (e.g., selecting a subset of the candidate options as the offered bid options 177, generation of text descriptions for each offered bid option 177 by which to present the respective value proposition). Inputs to the AI bid generator 255 can include the NSE predictions 162 as received from the NWDAF 160. In some implementations, the AI bid generator 255 further receives subscriber data (e.g., subscriber policy definitions 172, payment information, etc.) to aid in bid generation. In some implementations, the AI bid generator 255 can receive explicit feedback from subscribers, such as from subscriber surveys, from parsing service call information (e.g., when a subscriber reports an outage, etc.), etc. In some implementations, the AI bid generator 255 can receive implicit subscriber feedback data, such as data indicating subscriber conversion rates, subscriber retention and attrition rates, subscriber engagement and usage levels, etc. The data received by the AI bid generator 255 can be stored by the non-transient memory 240 (not shown) in any suitable form for ML processing.

In some implementations, the bid generation involves establishment, by the AI bid generator 255, of filtered or otherwise organized data spaces, such as multi-dimensional vector spaces, for use in maximizing value propositions, maximizing differences between value propositions, or achieving desired outcomes. In some implementations, the AI bid generator 255 implements one or more recommender systems to output highly relevant bid options 177 to users. In other implementations, ML feedback mechanisms, such as dynamic feedback evaluation based on defined fitness functions, can be used to achieve desired outcomes.

In some instances, the analytics front end processor 250 (e.g., the AI bid generator 255) can generate bid options 177 based on a single NSE prediction 162. For example, bid options 177 can be generated based only on predicted bandwidth utilization of a particular network slice in a particular timeframe. In other instances, the analytics front end processor 250 (e.g., the AI bid generator 255) can generate bid options 177 based on multiple NSE predictions 162. For example, bid options 177 can be generated based on an evaluation of predicted bandwidth utilization of each of multiple network slices in a particular timeframe, as well as predicted reliability of a set of RAN, 5G core, and/or IMS components during the same timeframe. When multiple NSE predictions 162 (e.g., and/or other data) is used to generate bid options 177, embodiments of the analytics front end processor 250 can combine the data in any suitable manner. For example, each of multiple NSE predictions 162 can be weighted in accordance with a weighting factor, such as a subscriber value associated with each NSE prediction 162, and/or a confidence score attributed to each NSE prediction 162; and the weighted NSE predictions 162 can then be combined.

Returning to FIG. 2, embodiments of the AFES 170 include an application programming interface (API) 220 to communicatively couple the analytics front end processor 250 with subscriber devices 110. As described above, the subscriber devices 110 are associated with subscribers to wireless communication services via one or more communication networks as managed by back-end network functions 140 (including the network policy server 145) based on respective network subscriber policy definitions 172. In some embodiments, the application programming interface 220 also provides a communication interface for one or more provider devices 180. For example, agents of the communication service provider and other non-subscriber entities can interface with the AFES 170 via the application programming interface 220.

The application programming interface 220 can be used to facilitate a number of bidding-related features, including outputting offered bid options 177 to users and receiving bid responses 277 from those users. Embodiments of the application programming interface 220 communicate with a user bidding interface 117 implemented on a user device, such as a subscriber device 110 or a provider device 180. The user bidding interface 117 can be provided in any suitable manner, for example, as part of a dedicated bidding application running on the user device, as a web-based portal accessible by the user device, as a background process running on the user device (e.g., by which to receive push notifications, or the like), as a web browser plugin running on the user device, as a messaging-based routine running on the user device (e.g., implemented as a set of text or SMS messages, as an automated response system running in a social media application, etc.), etc. The user bidding interface 117 can interact with a user interface system 230 of the user device, which provides for output to, and input from, a user of the device. For example, the user bidding interface 117 can cause the set of bid options 177 to be graphically displayed via a display of the user interface system 230, and the user can select one of the displayed bid options 177 (e.g., or other related options, etc.) using a touchscreen interface, integrated physical input device (e.g., integrated keyboard or touchpad), peripheral input device (e.g., connected mouse, keyboard, etc.), and/or other suitable user interface device of the user interface system 230. Selection of one or more of the offered bid options 177 can cause the user bidding interface 117 to generate one or more bid responses 277 and to communicate the one or more bid responses 277 back to the application programming interface 220 of the AFES 170.

In some cases, the user bidding interface 117 is implemented on subscriber devices 110 to facilitate interactive subscriber bidding. In other cases, the user bidding interface 117 can also be implemented on one or more provider devices 180, such as devices used by the communication service provider and/or any other party to services offered to the communication service provider and/or by the communication service provider. For example, provider devices 180 can be used by network infrastructure providers, over-the-top content providers, broadcast content providers, Internet service providers, application service providers (e.g., providers of a security system service, a streaming media service, etc.), etc. Depending on which devices are implementing the user bidding interface 117, the user bidding interface 117 may provide different options, capabilities, etc., and/or the user bidding interface 117 may be used for different purposes. As one example, subscribers may use user bidding interfaces 117 on their subscriber devices 110 to bid for different NSE for themselves. As another example, subscribers may use user bidding interfaces 117 on their subscriber devices 110 to bid for different NSE for other subscriber devices 110 (e.g., where the subscriber has different types of devices associated with different subscriber policy definitions 172), other subscribers (e.g., where different family members on a same account are associated with different subscriber policy definitions 172), etc. As another example, providers may use user bidding interfaces 117 on their provider devices 180 to generate sample bid offers, explore potential NSE-related changes or promotions, and/or for other reasons.

In some cases, the application programming interface 220 also facilitates receipt of certain types of bid presentation triggers 315 (shown in FIG. 3), and bid generation by the analytics front end processor 250 can be performed at least partially responsive to the bid presentation triggers 315. One category of bid presentation triggers 315 are subscriber-driven, pull-type bid presentation triggers 315. One example of such a bid presentation trigger is a subscriber pull trigger by which a subscriber generally requests to receive bid offers. For example, using a user bidding interface 117 on a subscriber device 110, a subscriber sends a general request for bids via the application programming interface 220 to the analytics front end processor 250. The request is received as a bid presentation trigger 315. In response to the trigger, the analytics front end processor 250 can query the NWDAF 160 for one or more NSE predictions 162, and/or use one or more previously requested NSE predictions 162, to generate bid options 177 that are responsive to the trigger.

Another example of such a bid presentation trigger 315 is another subscriber pull trigger by which a subscriber specifically requests a particular target NSE (e.g., by requesting a value or range of values of one or more attribute of a NSE definition) for which bid offers are desired. For example, using a user bidding interface 117 on a subscriber device 110, a subscriber sends a request for bids via the application programming interface 220 to the analytics front end processor 250, and the request indicates the specific target NSE attributes. For example, the subscriber's current plan offers a particular monthly data cap, and the subscriber's request is for a raise in their data cap. As in the previous example, the request is received as a bid presentation trigger 315, and the analytics front end processor 250 can generate bid options 177 that are responsive to the trigger.

Another example of such a bid presentation trigger 315 is another subscriber pull trigger by which a subscriber can access bid market data via the user bidding interface 117 and can participate in the generation of bid offers, such as by proposing one or more bid parameters based on the bid market data. As illustrated in FIG. 3, embodiments of the analytics front end processor 250 can implement a bid market engine 330 to generate the bid market data in a manner suitable for communication to, and/or presentation via, the user bidding interface 117. For example, a subscriber can request present network status trends in the form of graphs, data listings, dashboards, etc., from which the subscriber can see that resource utilization across the network (e.g., or for local network access nodes 130, for a particular network slice, etc.) is presently low. The subscriber can then propose a bid for access to some of the excess network resources (e.g., by proposing a desired QoS level and a proposed payment price. Alternatively, the bid market data can indicate a substantially real-time market of bid offers and prices being “traded” to (e.g., offered to, and accepted by) subscribers, such as similar to a commodities exchange, or the like; and the subscriber can offer to buy offered network resources, and/or to sell access to their allocated but unused network resources, based on the present market rates. In some such cases, generation of the bid market data for display via the user bidding interface 117 can involve interactions between the subscriber devices 110 and the analytics front end processor 250 via the application programming interface 220, and may further result in one or more queries from the analytics front end processor 250 to the NWDAF 160 via the network function interface 210. When the subscriber formulates a bid offer based on the bid market data, the bid offer can be communicated to the analytics front end processor 250 via the application programming interface 220 and received by the analytics front end processor 250 as a bid presentation trigger 315. The analytics front end processor 250 can then generate bid options 177 that are responsive to the trigger in a manner that indicates, for example, an acceptance or denial of the subscriber's offer based on present NSE predictions 162, one or more alternate bid offers generated based on the present NSE predictions 162 and based on the subscriber's offers (e.g., such that the offered set of bid options 177 has a logical correspondence to the type of offer the subscriber made), etc.

Another category of bid presentation triggers 315 are provider-driven, pull-type bid presentation triggers 315. One example of such a bid presentation trigger 315 is a provider pull trigger by which a provider generally requests to receive bid offers. For example, using a user bidding interface 117 on a provider device 180, a provider sends a general request for bids via the application programming interface 220 to the analytics front end processor 250. The request is received as a bid presentation trigger 315. In response to the trigger, the analytics front end processor 250 can query the NWDAF 160 for one or more NSE predictions 162, and/or use one or more previously requested NSE predictions 162, to generate bid options 177 that are responsive to the trigger. Such a bid presentation trigger 315 may be used by a provider, for example, to see whether there are any present opportunities for marketing to one or more types of subscriber's to maintain tracking of trends, etc.

Another example of such a bid presentation trigger 315 is another provider pull trigger by which a provider specifically requests a particular target NSE (e.g., by requesting a value or range of values of one or more attribute of a NSE definition) for which bid offers are desired. For example, using a user bidding interface 117 on a provider device 180, a provider sends a request for bids via the application programming interface 220 to the analytics front end processor 250, and the request indicates the specific target NSE attributes. For example, the provider is considering making a particular type of offer, changing a attributes of a particular subscription tier, and/or the like; and the request facilitates a determination of whether the change being considered by the provider would be commercially valuable. As in the previous example, the request is received as a bid presentation trigger 315, and the analytics front end processor 250 can generate bid options 177 that are responsive to the trigger.

Another example of such a bid presentation trigger 315 is another provider pull trigger by which a provider can access bid market data (e.g., generated by the bid market engine 330) via the user bidding interface 117 and can participate in the generation of bid offers, such as by proposing one or more bid parameters based on the bid market data. In embodiments where both subscribers and providers have access to bid market data, each may have access to the same or different portions of the data and/or in the same or different ways. For example, one or more providers may have access to more detailed information that do subscribers, one or more providers may have access to more regularly updated information than do subscribers, etc., one or more providers may have access only to anonymized and/or aggregated information for subscribers, etc. The one or more providers can use the bid market data to explore potential offers, sandbox promotions, track trends, etc. Generation of the bid market data for display via the user bidding interface 117 can involve interactions between the provider devices 180 and the analytics front end processor 250 via the application programming interface 220, and may further result in one or more queries from the analytics front end processor 250 to the NWDAF 160 via the network function interface 210. When the provider formulates a bid offer based on the bid market data, the bid offer can be communicated to the analytics front end processor 250 via the application programming interface 220 and received by the analytics front end processor 250 as a bid presentation trigger 315. The analytics front end processor 250 can then generate bid options 177 that are responsive to the trigger in a manner that indicates, for example, an acceptance or denial of the offer based on present NSE predictions 162, one or more alternate bid offers generated based on the present NSE predictions 162 and based on the provider's offers (e.g., such that the offered set of bid options 177 has a logical correspondence to the type of offer the subscriber made), etc.

Another category of bid presentation triggers 315 are push-type bid presentation triggers 315 generated at least partly autonomously by the analytics front end processor 250 and pushed to subscriber devices 110 and/or to provider devices 180. One example of such a bid presentation trigger 315 involves the analytics front end processor 250 continuously, periodically, and/or otherwise automatically being triggered to generate bid presentation offers. As shown in FIG. 3, embodiments of the analytics front end processor 250 implement a trigger generator 310 that can automatically generate bid presentation triggers 315 to cause generation of bid options 177 based on predetermined time interval (e.g., schedule, time period, etc.), relevance change detection (as described below), etc. For example, a bid scheduling engine periodically (e.g., at a predetermined regular time interval, at a certain time each day, etc.) issues a bid presentation trigger 315 for the analytics front end processor 250. The automatically generated bid presentation trigger 315 can cause automated generation of a set of bit options 177 for one or more subscriber device 110, for one or more provider devices 180, for one or more network slices, for one or more types of NSE prediction 162, etc. For example, different bid presentation triggers 315 can be generated at different times (e.g., at different time intervals) to trigger automatic generation of different types of bid options 177, such that some types of bid options 177 are automatically generated more regularly than others, at respective times of day, etc. In response to the trigger, the analytics front end processor 250 can query the NWDAF 160 for one or more NSE predictions 162, and/or use one or more previously requested NSE predictions 162, to generate bid options 177 that are responsive to the trigger. As noted above, the bid options 177 can be communicated to one or more users via a user bidding interface 117, and the one or more users may select one or more of the offered bid options 177.

Another example of such a bid presentation trigger 315 involves the analytics front end processor 250 monitoring a bid relevance of a previously accepted bid option 177 and automatically generating a bid presentation trigger 315 (e.g., by the trigger generator 310) when the bid relevance changes in a predetermined manner. In some cases, some or all offered bid options 177 include an associated relevance timeframe. For example, a bid option 177 is for increasing a subscriber's bandwidth for 24 hours for a certain price, such that the bid option 177 is only relevant for 24 hours (e.g., the subscriber's service would revert to its previous bandwidth level after the 24-hour timeframe ends). In such a case, as expiration of the selected bid offer 177 approaches (e.g., as the end of the 24-hour timeframe approaches), a bid presentation trigger 315 may be automatically generated to cause the analytics front end processor 250 automatically to generate new bid offers 177 for that subscriber. In some cases, at least one of the new offers can be an offer to extend the present offer, modify the current offer according to new NSE predictions 162, make the current offer a permanent part of the subscriber's subscriber policy definition 172, etc. In another case, the relevance of the offer may be based on present network status data 142, present NSE predictions 162, etc. For example, constant querying of NSE predictions 162 by the analytics front end processor 250 may reveal that there has been a drastic change in bandwidth demand, network access nodes 130 availability, and/or other conditions since a bid offer was accepted; and a bid presentation may automatically be generated, accordingly, to trigger the analytics front end processor 250 to propose a modified bid offer 177, or the like. As noted above, the bid options 177 can be communicated to one or more users via a user bidding interface 117, and the one or more users may select one or more of the offered bid options 177.

Another example of such a bid presentation trigger 315 involves the analytics front end processor 250 monitoring network conditions and automatically generating bid presentations triggers 315 (e.g., by the trigger generator 310) responsive to detecting predetermined threshold changes in network conditions. For example, the analytics front end processor 250 can continuously, periodically, or otherwise query the NWDAF 160 for NSE predictions 162 that may reveal changes in bandwidth supply and/or demand, network access node 130 availability, weather conditions, etc. In some cases, the monitoring seeks to determine changes in NSE for one or more subscribers (e.g., tracking data on dropped calls, buffering times, stalls, packet loss, actual upload and/or download data speeds, etc. When network, NSE, and/or other such changes cross certain respective thresholds, bid presentation triggers 315 can be automatically generated, and the analytics front end processor 250 can automatically generate bid options 177, accordingly. As noted above, the bid options 177 can be communicated to one or more users via a user bidding interface 117, and the one or more users may select one or more of the offered bid options 177.

Another example of such a bid presentation trigger 315 involves one or more users identifying (e.g., via the user bidding interface 117) various types or categories of bid offers of potential interest, the analytics front end processor 250 automatically generating bid presentations triggers 315 (e.g., by the trigger generator 310) responsive to monitoring for and detecting such types or categories of bid offers. For example, a subscriber can indicate in a preferences menu of a user bidding interface 117 that the subscriber desires to see any bid offers for temporary bandwidth increases; when the analytics front end processor 250 detects the availability of such a bid offer (e.g., based on monitoring NSE, monitoring network status, monitoring bid options being offered to other subscribers, etc.), a bid presentation trigger 315 is issued to trigger the analytics front end processor 250 to automatically generate appropriate bid options 177. As noted above, the bid options 177 can be communicated to one or more users via a user bidding interface 117, and the one or more users may select one or more of the offered bid options 177.

As described herein, the AFES 170 generates bid options 177 based on NSE predictions 162 received from the NWDAF 160 and provides the bid options 177 to user bidding interfaces 117 via the application programming interface 220 (and via one or more communication networks). The user bidding interface 117 facilitates display of the bid options 177 to one or more users in a manner that facilitates selection of one or more of the offered bid options 177 by the user. The selection generates a bid response 277, which is communicated back to the AFES 170 via the application programming interface 220. As illustrated, the AFES 170 is further in communication with the network policy server 145. Communications between the AFES 170 and the network policy server 145 can be implemented by the network function interface 210 and/or by the application programming interface 220. In either implementation, some embodiments of the AFES 170 (e.g., the analytics front end processor 250) are configured to generate one or more subscriber policy definitions 172 corresponding to the selected one or more bid options 177 (according to the bid response 277). Other embodiments of the AFES 170 (e.g., the analytics front end processor 250) are configured to generate instructions by which the network policy server 145 can generate, update, modify, or otherwise provide subscriber policy definitions 172 corresponding to the selected one or more bid options 177 (according to the bid response 277).

As described herein, the network policy server 145 directs how the network treats a subscriber's communications (e.g., which network access nodes 130 and/or other RAN components are used, which network slices are assigned, how much bandwidth is allocated, what data rates are supported, etc.) based on attributes indicated by the subscriber's subscriber policy definition 172; and those attributes effectively manifest as the subscriber's present NSE. By selecting a particular one of the bid options 177 (indicated by the bid response 277), the subscriber is effectively selecting the NSE definition associated with the selected bid option 177, and is committing to an exchange of value corresponding to the bid value associated with the selected bid option 177. The AFES 170 is configured to effectively execute a change (e.g., temporarily) in the subscriber policy definition 172 by modifying (or directing modification of) particular attribute values of the subscriber policy definition 172 in accordance with the associated NSE definition indicated by the bid response 277.

In one example, the back-end network functions 140 obtain network status data 142 from RAN components of the network, such as the gNodeB/UPF, that indicate edge node load via throughput speeds on the so-called “N3” interface between the gNodeB and the UPF. Such gNodeB congestion can be determined in accordance with physical resource block (PRB) utilization. For instance, a 10 MHz radio cell has 52 PRBs and back-end network functions 140 detect that 25 of the 52 PRBs are being utilized at a local time of 10:03 AM. The obtained network status data 142 is collected in the data lake 150. The analytics front end processor 250 queries the NWDAF 160 to obtain one or more NSE predictions 162 relating to PRB utilization levels based on the collected network status data 142 in the data lake 150. For example, the NWDAF 160 can train an AI/ML model to provide a present NSE prediction 162 of “QoS Value=N” for a present average uplink/downlink bitrate of 2 Megabits per second. The analytics front end processor 250 (e.g., AI bid generator 255) can use the present NSE prediction 162 to generate a number of related NSE definitions and associated values, each potentially corresponding to one of a set of bid options 177. The bid options 177 can be communicated to the user bidding interface 117 and displayed via a subscriber device 110. A subscriber can select one of the bid options 177 via the user bidding interface 117, causing a bid response 277 to be sent back to the analytics front end processor 250. The analytics front end processor 250 can map the NSE prediction 162 corresponding to the NSE definition for the selected bid option 177 back to a particular PRB utilization (e.g., 20-percent PRB utilization). The analytics front end processor 250 can then generate and/or push a subscriber policy definition 172 to the network policy server 145 that enforces a service experience for one or more subscribers based on the particular (e.g., 20-percent) PRB utilization.

In another example, illustrative network status data 142 stored in the data lake 150 includes the following:

| Sample | Bandwidth | Market | Time window | Error Rate |
|---|---|---|---|---|
| 1 | 5 | California | 10:10:05 | 10% |
| 2 | 10 | Colorado | 10:30:11 | 40% |
| 3 | 15 | Seattle | 11:00:02 | 60% |
| 4 | 20 | Montreal | 11:27:39 | 80% |
| N | 1 . . . n | A . . . Z | 00:00:00 . . . 24:00:00 | X % |

The example network status data 142 includes multiple samples of different network access nodes 130 (e.g., cells) in different markets and their corresponding bandwidths, error rates, etc. The data can be used by the NWDAF 160 to generate NSE predictions 162. For example, the NSE prediction 162 can indicate parametric value relationships, such as the following:

http post request with Level(param(int))=6 when Error Rate was 10%

http post request with Level(param(int))=10 when Error Rate was 40%

http post request with Level(param(int))=15 when Error Rate was 60%

http post request with Level(param(int))=20 when Error Rate was 80%

http post request with Level(param(int))=1 . . . n when Error Rate was 1 . . . n%

From this data, the analytics front end processor 250 can generate a set of bid options 177 such as corresponding to the following:

If Level(param(int))=1-5>Send Bid Value $((int)) to User

If Level(param(int))=6-10>Send Bid Value $((int)) to User

If Level(param(int))=11-15>Send Bid Value $((int)) to User

If Level(param(int))=15-20>Send Bid Value $((int)) to User

If Level(param(int))=1 . . . n>Send Bid Value $((int)) to User

For example, at each parametric value (“Level(param(int))”), providing a particular QoS (e.g., a particular NSE definition) to a subscriber is associated with a particular bid value. In response to subscriber selecting one of the bid options 177 corresponding, for example, to a parametric value of 11 (i.e., effectively to a particular NSE definition corresponding to that parametric value) and a bid value of some cash value, the analytics front end processor 250 can direct the network policy server 145 (e.g., as an API request http POST) to execute a corresponding change to that subscriber's subscriber policy definition 172.

Some embodiments of the AFES 170 can provide additional features associated with executing the change in subscriber policy definition 172. In some embodiments, the AFES 170 communicates with the network policy server 145 to execute a contractual update to reflect the change in subscriber policy definition 172. Such execution of a contractual update can, for example, involve prompting a subscriber (e.g., via the user bidding interface 117) to digitally sign an electronic contract, authenticating the subscriber prior to executing the change in subscriber policy definition 172, prompting the subscriber for an acceptance of certain terms and conditions, etc.

In some embodiments, the AFES 170 communicates with one or more back-end network functions 140 further to enforce the exchange of bid value associated with execution of the change to the subscriber policy definition 172. Such communication can be via the network policy server 145 and/or other back-end network functions 140 and can be implemented via the network function interface 210, the application programming interface 220, and/or in any other suitable manner. The exchange of bid value can include any suitable value exchange for the change in service. For example, the exchange of bid value can involve deducting a cash value from, or adding a cash value to a subscriber account statement; providing the subscriber with special access to additional subscription features (e.g., limited access content selections); providing the subscriber with loyalty rewards; etc.

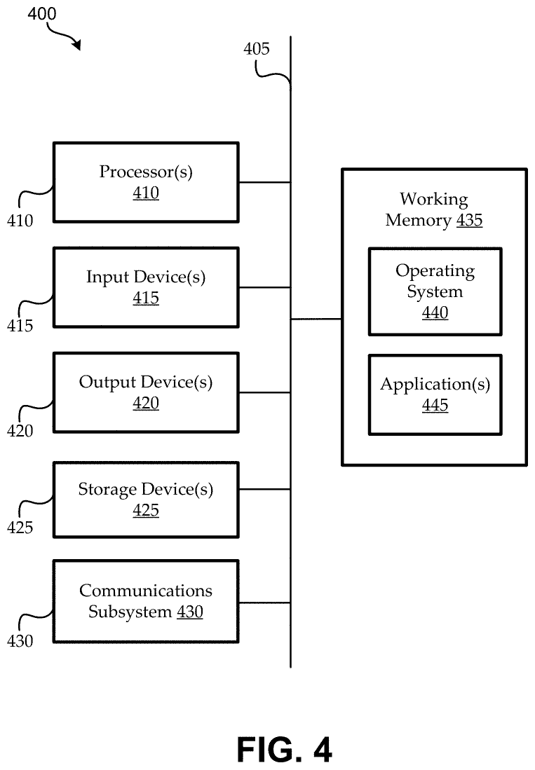

Embodiments of the analytics front-end system (AFES) 170, or components thereof, can be implemented on, and/or can incorporate, one or more computer systems, as illustrated in FIG. 4. FIG. 4 provides a schematic illustration of one embodiment of a computer system 400 that can implement various system components and/or perform various steps of methods provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405 (or may otherwise be in communication, as appropriate). The hardware elements may include one or more processors 410, including, without limitation, one or more general-purpose processors and/or one or more special-purpose processors (such as digital signal processing chips, graphics acceleration processors, video decoders, and/or the like). As illustrated, some embodiments include one or more input devices 415 and/or output devices 420 for human user input/output interactions. For example, input devices 415 can include, without limitation, buttons, knobs, switches, keypads, touchscreens, remote controls, and/or the like; and output devices 420 can include, without limitation, displays, indicators, gauges, and/or the like. As described herein, the computer system 400 is configured to interface with additional computers, such that the input devices 415 and/or output devices 420 include various physical and/or logical interfaces (e.g., ports, etc.) to facilitate computer-to-computer interaction and control. Embodiments of the input devices 415 and output devices 420 can be configured to implement the network function interface 210 and/or the application programming interface 220, so that the computer system 400 can interface with subscriber devices 110, provider devices 180, NWDAF 160, back-end network functions 140, etc.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 425 include the non-transient memory 240. In some embodiments, the storage devices 425 can include the data lake 150.

The computer system 400 can also include a communications subsystem 430, which can include, without limitation, any suitable antennas, transceivers, modems, network cards (wireless or wired), infrared communication devices, wireless communication devices, chipsets (such as a Bluetooth™ device, an 402.11 device, a WiFi device, a WiMax device, cellular communication device, etc.), and/or other communication components. As illustrated, the communications subsystem 430 generally includes any suitable components for facilitating communications with subscriber devices 110, the NWDAF 160, and the network policy server 145. Optionally, the communications subsystem 430 can further facilitate communications with other back-end network functions 140, provider devices 180, and/or other computational systems.

In many embodiments, the computer system 400 will further include a working memory 435, which can include a RAM or ROM device, as described herein. The computer system 400 also can include software elements, shown as currently being located within the working memory 435, including an operating system 440, device drivers, executable libraries, and/or other code, such as one or more application programs 445, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general purpose computer (or other device) to perform one or more operations in accordance with the described methods.

In some embodiments, the operating system 440 and the working memory 435 are used in conjunction with the one or more processors 410 to implement features of the AFES 170. Embodiments of the one or more processors 410 can implement the analytics front end processor 250, such that the operating system 440 and the working memory 435 can implement features of the analytics front end processor 250, such as the AI bid generator 255, generation and/or handling of bid presentation triggers (e.g., including related detection, scheduling, etc.), etc. In some embodiments, the working memory 435 includes non-transient, processor-readable memory having instructions stored thereon, which, when executed, cause the one or more processors 410 to perform steps including: obtaining one or more NSE predictions 162 derived by the NWDAF 160 based on network status data 142 received from back-end network functions 140; generating a set of bid options 177 based on the NSE predictions 162, each corresponding to a respective NSE definition and a respective bid value; outputting the set of bid options 177 for display by a user bidding interface 117; receiving a bid response 277 indicating a selected one of the set of bid options 177 that was selected via the user bidding interface 117; and directing the network policy server 145 to update one or more subscriber policy definitions 172 for one or more subscribers according to the respective NSE definition corresponding to the selected one of the set of bid options 177.

A set of these instructions and/or codes can be stored on a non-transitory computer-readable storage medium, such as the non-transitory storage device(s) 425 described above. In some cases, the storage medium can be incorporated within a computer system, such as computer system 400. In other embodiments, the storage medium can be separate from a computer system (e.g., a removable medium, such as a compact disc), and/or provided in an installation package, such that the storage medium can be used to program, configure, and/or adapt a general purpose computer with the instructions/code stored thereon. These instructions can take the form of executable code, which is executable by the computer system 400 and/or can take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which can be incorporated into the operating system 440 and/or other code, such as an application program 445) contained in the working memory 435. Such instructions may be read into the working memory 435 from another computer-readable medium, such as one or more of the non-transitory storage device(s) 425. Merely by way of example, execution of the sequences of instructions contained in the working memory 435 can cause the processor(s) 410 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 400, various computer-readable media can be involved in providing instructions/code to processor(s) 410 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 425. Volatile media include, without limitation, dynamic memory, such as the working memory 435. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code. Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer can load the instructions into its dynamic memory and send the instructions as signals over a transmission medium to be received and/or executed by the computer system 400. The communications subsystem 430 (and/or components thereof) generally will receive signals, and the bus 405 then can carry the signals (and/or the data, instructions, etc., carried by the signals) to the working memory 435, from which the processor(s) 410 retrieves and executes the instructions. The instructions received by the working memory 435 may optionally be stored on a non-transitory storage device 425 either before or after execution by the processor(s) 410.

It should further be understood that the components of computer system 400 can be distributed across a network. For example, some processing may be performed in one location using a first processor while other processing may be performed by another processor remote from the first processor. Other components of computer system 400 may be similarly distributed. As such, computer system 400 may be interpreted as a distributed computing system that performs processing in multiple locations. In some instances, computer system 400 may be interpreted as a single computing device, such as a distinct laptop, desktop computer, or the like, depending on the context.

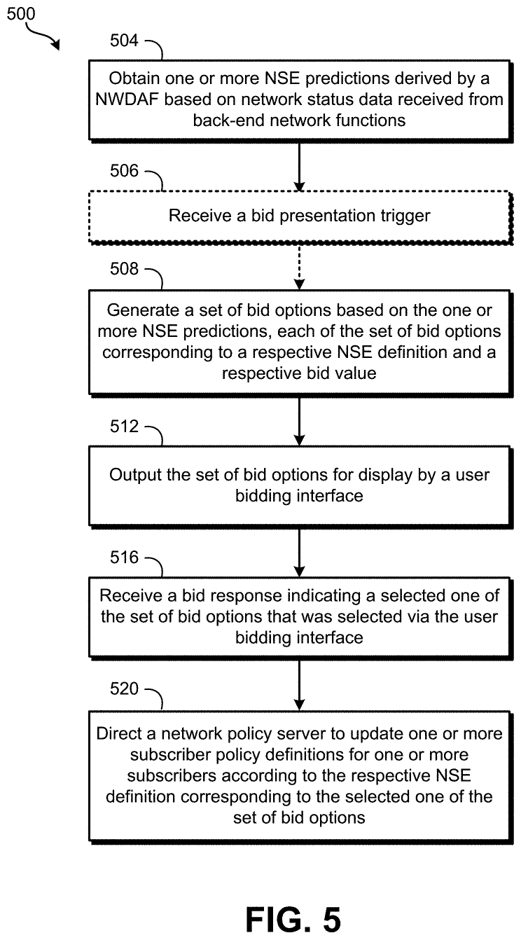

FIG. 5 shows a flow diagram of an illustrative method 500 for dynamic bid-driven reconfiguration in a wireless communication network, according to various embodiments. The method 500 can be implemented using any suitable system, including those described above in FIGS. 1-4. Embodiments of the method 500 begin at stage 504 by obtaining (e.g., by an analytics front-end system (AFES)), one or more network service experience (NSE) predictions. The NSE predictions are derived by a network data analytics function (NWDAF) based on network status data received from back-end network functions.

At stage 508, embodiments can generate (e.g., by the AFES) a set of bid options based on the one or more NSE predictions. Each of the set of bid options can correspond to a respective NSE definition and a respective bid value. In some embodiments, the AFES includes an analytics front end processor that includes an artificial intelligence (AI) based bid generator. For example, the AI-based bid generator implements a machine-learning recommendation engine configured to generate the set of bid options from the NSE prediction data.

In some embodiments, at stage 506, the method 500 includes receiving a bid presentation trigger, and subsequent generating at stage 508 is in accordance with the bid presentation trigger. In some such embodiments, as described above, the bid presentation trigger is a subscriber-driven pull-type bid presentation trigger received from a requesting subscriber of the one or more subscribers via the user bidding interface running on one of the subscriber devices. In other such embodiments, as described above, the bid presentation trigger is a provider-driven pull-type bid presentation trigger received from a provider of the wireless communication services via the user bidding interface running on a provider device of the provider. In other such embodiments, as described above, the bid presentation trigger is generated automatically by the AFES in accordance with a predetermined schedule. In other such embodiments, as described above, the bid presentation trigger is generated automatically by the AFES responsive to the AFES detecting at least a predetermined threshold change in network conditions (e.g., a change in NSE predictions, a change in actual present NSE of one or more subscribers, a change in network status data, etc.). In other such embodiments, as described above, the bid presentation trigger is generated automatically by the AFES in response to the AFES determining an expiry of relevance of a presently active bid option. For example, the AFES can determine an upcoming expiration of a relevance timeframe associated with a presently active bid option that was selected by one of the one or more subscribers prior to the generating in stage 508. The presently active bid option can be from a prior iteration of the method 500 that resulted in a prior generation of bid options, from which the presently active bid option was selected, and which is currently affecting at least one subscriber's subscriber policy definition. In such cases, the generating at stage 508 can be further based on the presently active bid option, such that at least one of the set of bid options generated in stage 508 corresponds to an extension of the relevance timeframe of the presently active bid option.

At stage 512, embodiments can output (e.g., via an application programming interface of the AFES) the set of bid options for display by a user bidding interface. The user bidding interface can be implemented in any suitable manner on a user device, such as on subscriber devices and/or on provider devices. The application programming interface is configured to communicatively couple with subscriber devices associated with subscribers to wireless communication services managed by a network policy server based on respective subscriber policy definitions. At stage 516, embodiments can receive (e.g., via the application programming interface of the AFES), responsive to the outputting, a bid response indicating a selected one (or more) of the set of bid options that was selected via the user bidding interface. For example, the user is presented with the bid options in an interactive interface that facilitates the user being able to select one of the presented options.

At stage 520, embodiments can direct the network policy server (e.g., by the AFES) to update one or more of the respective subscriber policy definitions for one or more of the subscribers according to the respective NSE definition corresponding to the selected one of the set of bid options. For example, one or more new subscriber policy definitions for one or more subscribers can be loaded to the network policy server, instructions can be provided to the network policy server by which the network policy server can generate or update one or more subscriber policy definitions for one or more subscribers, and/or attributes and/or attribute values can be sent to the network policy server for use by the network policy server in generating or updating one or more subscriber policy definitions for one or more subscribers. In some embodiments, the directing at stage 520 also includes directing one or more of the back-end network functions to digitally execute one or more contracts for the changes in subscriber policy definitions, and/or to update subscriber accounts for the one or more of the subscribers according to the respective bid value corresponding to the selected one of the set of bid options.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A system for dynamic bid-driven reconfiguration in a wireless communication network, the system comprising:
a network function interface to communicatively couple with a network data analytics function (NWDAF) and a network policy server via a communication network;
an application programming interface to communicatively couple with a plurality of subscriber devices via the communication network, the subscriber devices being associated with subscribers to wireless communication services via the communication network managed by the network policy server based on respective subscriber policy definitions;
an analytics front end processor coupled between the network function interface and the application programming interface; and
a non-transient memory having instructions stored thereon, which, when executed, cause the analytics front end processor to perform steps comprising:
obtaining, via the network function interface, one or more network service experience (NSE) predictions derived by the NWDAF based on network status data received from a plurality of back-end network functions;
generating a set of bid options based on the NSE predictions, each of the set of bid options corresponding to a respective NSE definition and a respective bid value;
outputting, via the application programming interface, the set of bid options for display by a user bidding interface;
receiving, via the application programming interface, responsive to the outputting, a bid response indicating a selected one of the set of bid options that was selected via the user bidding interface; and
directing the network policy server, via the network function interface, to update one or more of the respective subscriber policy definitions for one or more of the subscribers according to the respective NSE definition corresponding to the selected one of the set of bid options.

2. The system of claim 1, wherein the steps further comprise:
receiving a bid presentation trigger,
wherein the generating is in accordance with the bid presentation trigger.

3. The system of claim 2, wherein the bid presentation trigger is a subscriber-driven pull-type bid presentation trigger received from a requesting subscriber of the one or more subscribers via the user bidding interface running on one of the subscriber devices.

4. The system of claim 2, wherein the bid presentation trigger is a provider-driven pull-type bid presentation trigger received from a provider of the wireless communication services via the user bidding interface running on a provider device of the provider.

5. The system of claim 2, wherein the bid presentation trigger is generated automatically by the analytics front end processor in accordance with a predetermined schedule.

6. The system of claim 2, wherein:
the bid presentation trigger is generated automatically by the analytics front end processor in response to the analytics front end processor determining an upcoming expiration of a relevance timeframe associated with a presently active bid option that was selected by one of the one or more subscribers prior to the generating; and
the generating is further based on the presently active bid option, such that at least one of the set of bid options corresponds to an extension of the relevance timeframe of the presently active bid option.

7. The system of claim 2, wherein the bid presentation trigger is generated automatically by the analytics front end processor responsive to the analytics front end processor detecting at least a predetermined threshold change in network conditions.

8. The system of claim 1, wherein the directing further comprises:
directing one or more of the back-end network functions to update subscriber accounts for the one or more of the subscribers according to the respective bid value corresponding to the selected one of the set of bid options.

9. The system of claim 1, wherein the analytics front end processor comprises a machine-learning recommendation engine configured to generate the set of bid options from the NSE predictions.

10. The system of claim 1, further comprising:
a data lake coupled with the NWDAF and the plurality of back-end network functions to collect the network status data,
wherein the NWDAF implements one or more artificial intelligence/machine learning (AI/ML) engines that receive the network status data from the data lake.

11. A method for dynamic bid-driven reconfiguration in a wireless communication network, the method comprising:
obtaining, by an analytics front-end system (AFES), one or more network service experience (NSE) predictions derived by a network data analytics function (NWDAF) based on network status data received from a plurality of back-end network functions;
generating, by the AFES, a set of bid options based on the one or more NSE predictions, each of the set of bid options corresponding to a respective NSE definition and a respective bid value;
outputting, via an application programming interface of the AFES, the set of bid options for display by a user bidding interface, the application programming interface to communicatively couple with a plurality of subscriber devices associated with subscribers to wireless communication services managed by a network policy server based on respective subscriber policy definitions;
receiving, via the application programming interface of the AFES, responsive to the outputting, a bid response indicating a selected one of the set of bid options that was selected via the user bidding interface; and
directing the network policy server, by the AFES, to update one or more of the respective subscriber policy definitions for one or more of the subscribers according to the respective NSE definition corresponding to the selected one of the set of bid options.

12. The method of claim 11, further comprising:
receiving a bid presentation trigger,
wherein the generating is in accordance with the bid presentation trigger.

13. The method of claim 12, wherein the bid presentation trigger is a subscriber-driven pull-type bid presentation trigger received from a requesting subscriber of the one or more subscribers via the user bidding interface running on one of the subscriber devices.

14. The method of claim 12, wherein the bid presentation trigger is a provider-driven pull-type bid presentation trigger received from a provider of the wireless communication services via the user bidding interface running on a provider device of the provider.

15. The method of claim 12, wherein the bid presentation trigger is generated automatically by the AFES in accordance with a predetermined schedule.

16. The method of claim 12, wherein:
the bid presentation trigger is generated automatically by the AFES in response to the AFES determining an upcoming expiration of a relevance timeframe associated with a presently active bid option that was selected by one of the one or more subscribers prior to the generating; and
the generating is further based on the presently active bid option, such that at least one of the set of bid options corresponds to an extension of the relevance timeframe of the presently active bid option.

17. The method of claim 12, wherein the bid presentation trigger is generated automatically by the AFES responsive to the AFES detecting at least a predetermined threshold change in network conditions.

18. The method of claim 11, wherein the directing further comprises:
directing one or more of the back-end network functions to update subscriber accounts for the one or more of the subscribers according to the respective bid value corresponding to the selected one of the set of bid options.

19. The method of claim 11, wherein the AFES comprises an analytics front end processor that implements a machine-learning recommendation engine configured to generate the set of bid options from the NSE prediction data.

20. The method of claim 11, wherein:
wherein the NWDAF implements one or more artificial intelligence/machine learning (AI/ML) engines that receive the network status data from a data lake coupled between the NWDAF and the plurality of back-end network functions.
